(19) United States
(12) Patent Application Publication
(10) Pub. No.: US 2015/0025950 A1
(43) Pub. Date: Jan. 22, 2015

(54) METHOD AND SYSTEM FOR PROVIDING CONFIGURABLE VARIABLE REVENUE SHARING IN ONLINE COMMERCE

(71) Applicant: NetFin Works Information Technology (Shanghai) Co., Ltd., Shanghai (CN)

(72) Inventor: Qianghua YU, Shanghai (CN)

(21) Appl. No.: 14/333,446

(22) Filed: Jul. 16, 2014

(30) Foreign Application Priority Data
Jul. 18, 2013 (CN) 201310302495.9

(51) Int. Cl. G06Q 30/02

(52) U.S. Cl. CPC G06Q 30/0274
USPC 705/14.7

(57) ABSTRACT

Method and server system for providing configurable variable revenue sharing in online commerce are disclosed. The method includes: receiving a revenue sharing configuration for each promoter in a promotion chain; receiving a purchase notification for a sale of a respective merchandise established by a respective one of the promoters in the promotion chain; identifying the respective revenue sharing configurations of the respective one of the promoters and all other promoters above the respective one of the promoters in the promotion chain; and distributing payment received for the sale among the respective one of the promoters and all the other promoters above the respective one of the promoters in the promotion chain.

### PRIORITY CLAIM AND RELATED APPLICATION

This application claims priority to Chinese Patent Application No. 201310302495.9, entitled “METHOD AND SYSTEM FOR VARIABLE REVENUE SHARING IN ONLINE COMMERCE”, filed on Jul. 18, 2013, which is incorporated by reference in its entirety.

### TECHNICAL FIELD

The disclosed implementations relate to the field of information processing technologies, and in particular, to a method and system for providing configuration variable revenue sharing in online commerce.

### BACKGROUND

With the rapid development of online commerce, large online commerce platforms (e.g., shopping portals) continue to emerge. Most of these commerce platforms provide account settlement services. When the sales proceeds are received, the revenue is divided among the different right holders (e.g., seller, platform service providers, shipping service providers, etc.). For example, when one hundred dollars worth of merchandise is sold through a commerce platform, 5 dollars out of the 100 dollars are given to the commerce platform as transaction fees, and 95 dollars are the revenue of the seller. Presently, some most complex account settlement scenarios are provided by large commerce platforms, such as Taobao, which facilitate online shops and promoter services. These online shopping platforms allow a seller to set how much discount it is willing to offer to a promoter, and configure whether it is willing to pay for any insurance cost. For example, a seller can set up an offer of 1 dollar for shipping insurance, and 20% discount for a promoter. In such an example scenario, when a buyer enters the shopping platform (e.g., Taobao) through the promoter's webpage and bought one hundred dollars worth of goods, the shopping platform will credit 1 dollar to the account of an insurance company supplying the shipping insurance, credit 20 dollars to the account of the promoter, and credit the remaining 79 dollars to the account of the seller. Presently, the account settlement services provided by the commerce platforms only use pre-established settlement rules, each participant of the commerce activities (e.g., selling and promoting) can only make very rudimentary adjustments to the values of established parameters (e.g., setting the numerical numbers for the parameters) in the pre-established settlement rules provided by the commerce platform. This does not meet the requirement of the participants' need for more autonomous management of their own settlement requirements.

### SUMMARY

To address the inadequacies of the rigid account settlement mechanisms provided by existing commerce platforms, the embodiments of the present disclosure provide methods and systems for providing configurable and variable revenue sharing in online commerce.

In addition or alternative to selecting a fixed revenue sharing configuration, and making minor adjustment to the predetermined parameters in the fixed revenue sharing configuration, the present disclosure provides a method and system that facilitates sellers (i.e., top-level promoters) and promoters of a product to create and configure variable payment division rules that can be automatically adjusted based on the identity and/or characteristics of the promoters and/or sub-promoters (e.g., new, old, past promotion records, areas of expertise, etc.), identity and/or characteristics of the buyers (e.g., age, gender, location, influence to peers, income level, online activity history, shopping history, etc.), various characteristics of the purchase context (e.g., marketing goals, inventory levels, cash flow, shipping volume, overall sales volumes, market conditions, etc.), and various characteristics of the sale itself (e.g., shopping platform used, time, location, previous shopping history, sale quantity, sale amount, etc.).

In addition, in some embodiments, the method and system not only facilitates the selection of sub-promoters by the sellers of goods and services and upper-level promoters, but also facilitates the selection of upper-level promoters by potential sub-promoters of the upper-level promoters.

In addition, in some embodiments, each sub-promoter can be paired with a corresponding upper-level promoter at the time the promotion act actually happens (e.g., when the upper-level promoter sends a promoted product to the sub-promoter via a social network platform). In some embodiments, each upper-level promoter can also configure the revenue sharing configuration for each of its sub-promoters when the upper-level promoter has selected the sub-promoter and is about to share a product with the selected sub-promoter. In some embodiments, the revenue sharing configuration offered by the upper-level promoter may optionally include variable payment division rules that depend on various variables (e.g., location, time, buyer characteristics, sub-promoter characteristics, etc.).

By providing the flexibility in selecting upper-level promoters and sub-level promoters, and configurability of variable payment division rules based on different characteristic parameters and sales/promotion context, the formation of valuable promotion chains can be enabled and enhanced.

Furthermore, the account settlement services disclosed herein can track the formation of a promotion chain (i.e., a chain of promoters linking the seller (i.e., the top-level promoter) and the buyer), identify the most relevant payment division rules established between each pair of promoters (i.e., a promoter and its sub-promoter) in the promotion chain, and provide correct credit and cost attributions to each party of the promotion chain based on the characteristics of the current sale (e.g., the time and location of the promotions and/or sale, and the characteristics of the promoter(s) and buyer) and the variables in the payment division rules.

In accordance with some implementations of the present application, a method for facilitating configurable variable revenue sharing (including cost sharing) is performed at a server system having one or more processors and a memory. The method includes: at a server having one or more processors and memory: receiving a respective revenue sharing configuration for each of a sequence of promoters in a promotion chain of a product, wherein the respective revenue sharing configuration specifying at least one payment division rule established between a corresponding promoter and a respective sub-promoter of the corresponding promoter in the promotion chain, and wherein the payment division rule includes at least a sale price and a promotion price for a respective merchandise item established for the product by the corresponding promoter, the sale price being a price given to a potential buyer of the respective merchandise item, and the promotion price being a price given to the respective sub-promoter of the corresponding promoter; receiving a purchase notification for the product, wherein the purchase notification specifying a sale of the respective merchandise established by a respective one of the promoters in the promotion chain; in response to the purchase notification, identifying the respective revenue sharing configurations of the respective one of the promoters and all other promoters above the respective one of the promoters in the promotion chain; and distributing payment received for the sale among the respective one of the promoters and all the other promoters above the respective one of the promoters in the promotion chain based on the payment division rules in the identified respective revenue sharing configurations.

In another aspect, a computer system (e.g., server system 108, FIGS. 1A-1B, and FIG. 2) includes one or more processors and memory storing one or more programs for execution by the one or more processors, the one or more programs include instructions for performing, or controlling performance of, the operations of any of the methods described herein. In some embodiments, a non-transitory computer readable storage medium storing one or more programs, the one or more programs comprising instructions, which, when executed by a computer system with one or more processors, cause the computer system to perform, or control performance of, the operations of any of the methods described herein. In some embodiments, a computer system includes means for performing, or controlling performance of, the operations of any of the methods described herein. In some embodiments, the client-side devices perform corresponding actions required to facilitate the performance of the methods performed by the server.

Various advantages of the disclosed technology are apparent in light of the descriptions below.

### BRIEF DESCRIPTION OF THE DRAWINGS

The aforementioned features and advantages of the disclosure as well as additional features and advantages thereof will be more clearly understood hereinafter as a result of a detailed description of preferred embodiments when taken in conjunction with the drawings.

To illustrate the technical solutions according to the embodiments of the present application more clearly, the accompanying drawings for describing the embodiments are introduced briefly in the following. The accompanying drawings in the following description are only some embodiments of the present application; and persons skilled in the art may obtain other drawings according to the accompanying drawings without any creative efforts.

FIG. 1A is a block diagram of a server-client environment in accordance with some embodiments.

FIG. 1B is a block diagram of the server system shown in FIG. 1A in accordance with some embodiments.

FIG. 2 is a block diagram of a server system in accordance with some embodiments.

FIG. 3 is a block diagram of a client device in accordance with some embodiments.

FIGS. 4A-4H illustrate exemplary user interfaces for configuring a variable revenue sharing configuration by a promoter of a product, sharing the product with a sub-promoter, and obtaining account settlement based on sale of the product and the associated promotion chain used in the sale of the product in accordance with some embodiments.

FIGS. 5A-5B are a flowchart diagram of a method for providing configurable variable revenue sharing in online commerce in accordance with some embodiments.

Like reference numerals refer to corresponding parts throughout the several views of the drawings.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the subject matter presented herein. But it will be apparent to one skilled in the art that the subject matter may be practiced without these specific details. In other instances, well-known methods, procedures, components, and circuits have not been described in detail so as not to unnecessarily obscure aspects of the embodiments.

The following clearly and completely describes the technical solutions in the embodiments of the present application with reference to the accompanying drawings in the embodiments of the present application. Apparently, the described embodiments are merely a part rather than all of the embodiments of the disclosed technology. All other embodiments obtained by persons of ordinary skill in the art based on the embodiments of the present application without creative efforts shall fall within the protection scope of the present application.

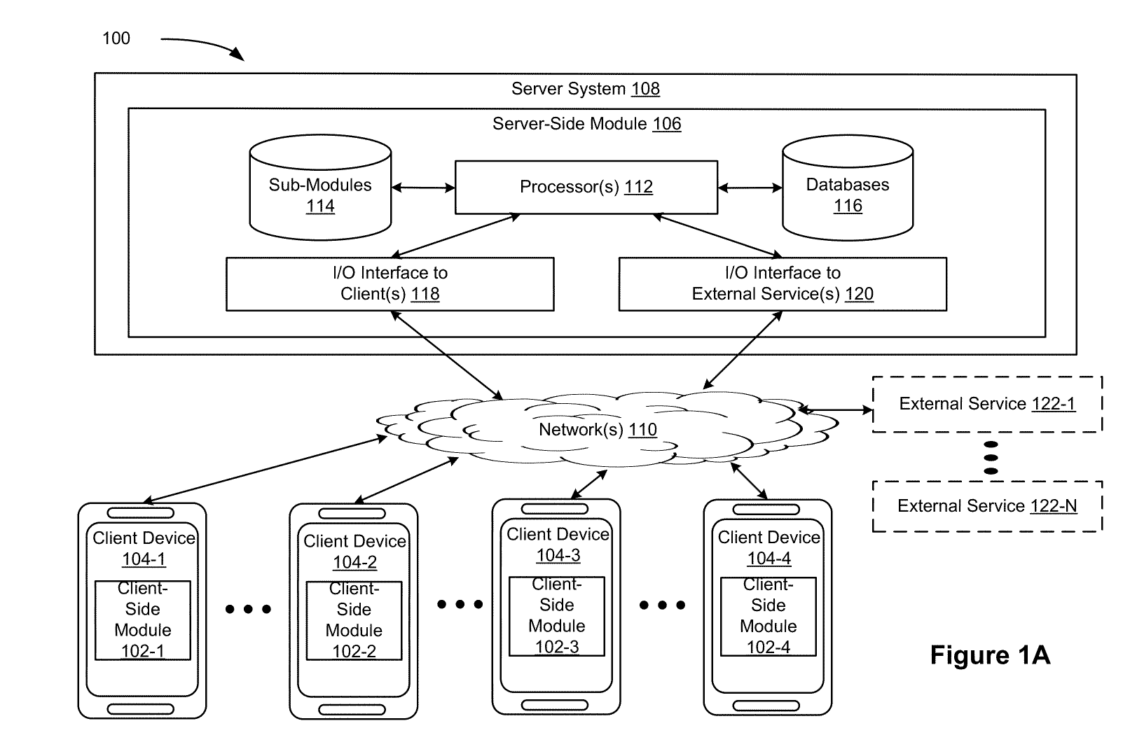

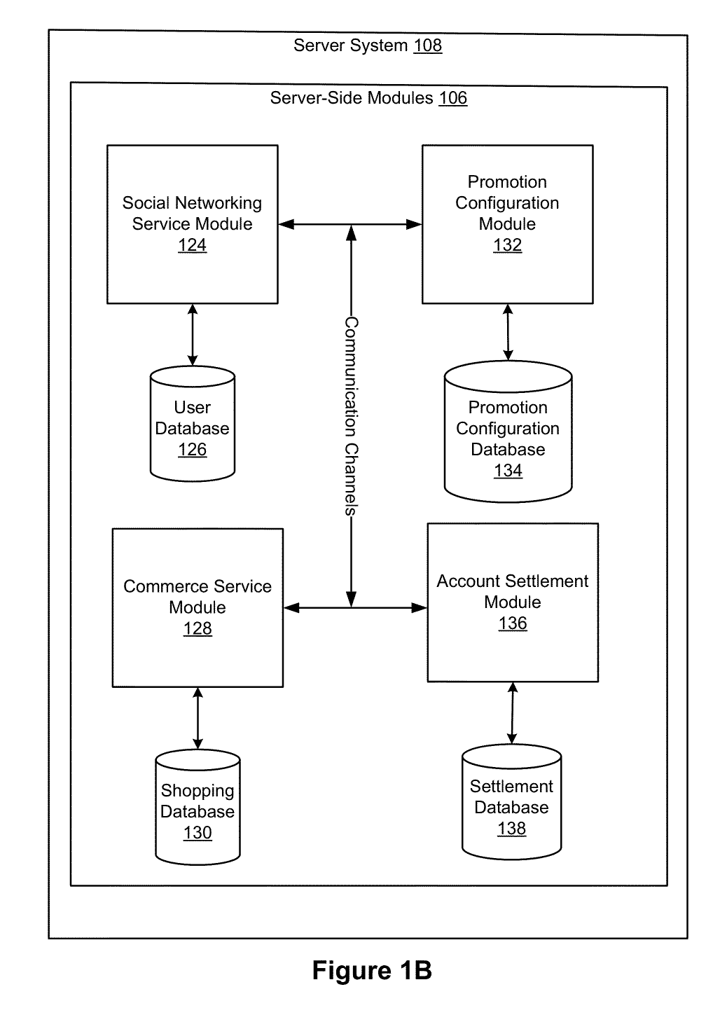

As shown in FIG. 1A, providing configurable variable revenue sharing in online commerce is implemented in a server-client environment 100 in accordance with some embodiments.

In accordance with some embodiments, server-client environment 100 includes client-side processing 102-1, 102-2, 102-3, 102-4 (hereinafter “client-side module 102”) executed on client devices 104-1, 104-2, 104-3, 104-4 and server-side processing 106 (hereinafter “server-side module 106”) executed on a server system 108. In actual implementations, the server-side processing 106 may be performed by several server systems in collaboration. In addition, the different client devices 102 may take on different roles at different times depending on the activity that is performed by the client-side module 102. The client-side module 102 may include more than one sub-modules that operate independently of each other (e.g., as different client software applications) or can operate together in collaboration.

Client-side module 102 communicates with server-side module 106 through one or more networks 110. Client-side module 102 provides client-side functionalities for the commerce, promotion, and social networking platforms (e.g., online stores management, online shopping, payment rule configuration, management of upper-level promoters, sub-level promoters, and promoted products, promotion activities such as product sharing via instant messaging or other social networking services, normal social networking activities, etc). Client-side module 102 accomplishes much of the client-side functionalities through communications with server-side module 106 or its sub-modules 114 (e.g., including social networking service module 124, commerce service module 128, promotion configuration module 132, and account settlement module 136, etc.).

Server-side module 106 provides server-side functionalities for the commerce, promotion, and social networking platforms. In some embodiments, the server-side module 106 includes multiple sub-modules or modules managed by different service entities. For example, as shown in FIG. 1B, the sever side module 106 may optionally include social networking service module 124 which provides social networking services (e.g., instant messaging, and/or other social networking services) for any number of client modules 102 each residing on a respective client device 104. In some embodiments, the social networking service module 124 interfaces with one or more third-party social network platforms, to enable sharing and promotion of product information by a promoter over the third-party social networking platforms (e.g., sending instant messages containing product information to social network contacts, posting product information on personal blogs, public account message boards, personal webpages, etc.). In some embodiments, the social networking service module 124 has access to a user database 126. The user database 126 includes user characteristics for users on the social networking platform(s). For example, the user database 126 includes for each social networking platform, corresponding user IDs, and user characteristics (e.g., demographic characteristics, contact lists, follower lists, social network usage history, etc.) for each user ID). The information in the user database 126 can be used by the account settlement module to provide buyer characteristics in actual sales, for example.

In some embodiments, the sever side module 106 may optionally include commerce service module 128 which provides online commerce services (e.g., provide online storefronts for sellers, and online shopping cart and payment processing services for buyers, etc.) to sellers and buyers. In some embodiments, the commerce service module 128 interfaces with one or more third-party online commerce platforms to provide the online commerce services. In some embodiments, the commerce service module 128 has access to a shopping database 130. The shopping database 130 includes shopping related data, such as order information (e.g., buyer ID, seller ID, product ID, order quantity, order amount, payment information, transaction time, shipping methods, etc.), product review information, transaction review information, seller rating, buyer rating, payment account information, etc. The commerce service module can communicate with the account settlement module 136 to provide notification of sales as well as characteristics related to the seller and buyers for the sales, or data related to the sale itself (e.g., location, time, amount, quantity, market conditions at the time of sale, forecast of market conditions, inventory level, shipping delay, etc.).

In some embodiments, the server-side module 106 further includes a promotion configuration module 132. The promotion configuration module 132 provides user interfaces for management and selection of sub-promoters for each user that has become a promoter of online merchandise. The original seller of an online product or service is the top-level promoter of the online product or service. Each promoter of a product can select one or more sub-promoters to promote the product, and each of the sub-promoters can also select one or more others to become its own sub-promoters for the product. When the product is purchased by a buyer through the promotion efforts of a chain of promoters (e.g., the chain that includes the seller and a sequence of lower-level promoters), the proceeds received from the buyer for the sale can be divided among the seller and the lower-level promoters, and fees can be paid to various service providers involved in the sale and promotion (e.g., insurance, shipping, platform service providers).

In some embodiments, the promotion configuration server 132 also provides a platform for the promoters of products to search for suitable sub-promoters for its goods, and for users who want to become a sub-promoter to find its upper-level promoters. The platform allows potential upper-level promoters and lower-level promoters to post their products, criteria for searching promotion affiliates, past promotion records, and offers of revenue sharing configurations that may be agreeable to potential upper-level or lower-level promoters.

In some embodiments, the promotion configuration server 132 may also offer user interfaces for establishing and configure variable revenue sharing configurations on an individual product basis, as well as on an individual promoter basis. The variable revenue sharing configuration may optionally include variable parameters (e.g., sale location, sale time, buyer ID, promoter ID, promoter characteristics, buyer characteristics, promotion time, promotion location, etc.) which take on different values depending on the actual promotion and sale of the product, as well as external market factors (e.g., overall sales, number of promoters in the promotion chain, shipping delays, market conditions, etc.).

In addition, each variable revenue sharing configuration specifies the payment division rules (including any cost division rules) between a pair of adjacent promoters in the promotion chain of a product to be sold. Each variable revenue sharing configuration provides different payment division outcomes based on different values taken on by the variable parameters in the variable revenue sharing configuration. The actual payment division rules used in the final account settlement is based on the actual values taken on by the variable parameters based on the actual sale situation.

In some embodiments, the promotion configuration module 132 has access to a promotion configuration database 134. The promotion configuration database 134 includes the promoter IDs for registered promoters and associated promotion information. In some embodiments, the promoter IDs are also linked with the account IDs of the promoters on different social network platforms, online commerce platforms, and online payment platforms. In some embodiments, for each promoter ID, the associated promotion information includes the IDs of upper-level promoters and associated merchandise shared by the upper-level promoters. In some embodiments, for each promoter ID, the associated promotion information includes the IDs of lower-level promoters and associated merchandise that has been shared with the lower-level promoters.

In some embodiments, for each product or each group of products shared by a given upper-level promoter, each sub-promoter of the upper-level promoter is also associated with a respective promotion configuration (also referred to as a revenue sharing configuration) between the sub-promoter and the upper-level promoter. In some embodiments, for each product or each group of products shared with a given lower-level promoter, the lower-level promoter is also associated with a respective promotion configuration (also referred to as a revenue sharing configuration) between the lower-level promoter and its own sub-promoter. In some embodiments, for each product of a given promoter promotes, the given promoter can establish one or more revenue sharing configurations, and each revenue sharing configuration is available for selection by a potential sub-promoter. When a sub-promoter selects one of the available revenue sharing configurations, the promoter ID of the sub-promoter is associated with the given promoter's promoter ID and with the selected revenue sharing configuration. In some embodiments, the promoter ID of a sub-promoter is not associated with any revenue sharing configuration until the sub-promoter has actually performed a promotion activity (e.g., shared the product information with another user (e.g., a potential buyer or one of its own sub-promoters)).

In some embodiments, the server-side module 106 includes an account settlement module 136. In some embodiments, the account settlement module 136 interfaces with the commerce service module 128 to receive order confirmation for a sale of a product. In some embodiments, the account settlement module 136 also interfaces with the promotion configuration module 132 to obtain promotion chain information for the sale of a product, and revenue sharing configurations of the promoters in the promotion chain for the sale of the product. In some embodiments, the accounting settlement module 136 is also interfaced with the social networking service module 124 to obtaining the buyer information. In some embodiments, the account settlement module 136 is also interfaced with one or more other modules and/or external services 122 (e.g., 122-1 to 122-N) to obtain other relevant information (e.g., marketing information services, previous sales/promotion records, service provider information, etc.) needed to determine the proper payment divisions (as well as cost divisions) among the promoters in the promotion chain for the sale of the product. In some embodiments, the account settlement module 136 is also interfaced with one or more payment account servers to ensure that the proper amount of payment proceeds are credited to each of the promoters (including the seller) for the sale of the product, and that the costs are properly paid to each of the non-promoter parties, such as the insurance provider, the shipping service, etc. In some embodiments, the account settlement module 136 also records and updates the promotion successes for each promoter and for each product in a settlement database. In some embodiments, the account settlement module 136 stores account settlement information for each individual sale in the settlement database 138 immediately after the sale, and provides aggregation and makes actual account transfers of the aggregated payments to each party periodically or according to individual agreements established with each party.

In some embodiments, as shown in FIG. 1A, server-side module 106 (including its sub-modules such as the social networking service module 124, the commerce service module 128, the promotion configuration module 132, and the account settlement module 136) includes one or more processors 112, one or more databases 116 (e.g., including the user database 126, the shopping database 130, the promotion configuration database 134, and the settlement database 138), an I/O interface to one or more clients 118, and an I/O interface to one or more external services 120. I/O interface to one or more clients 118 facilitates the client-facing input and output processing for server-side module 106. I/O interface to one or more external services 120 facilitates communications with one or more external services 122 (e.g., merchant websites, shipping companies, insurance companies, credit card companies, and/or other payment processing services).

Examples of client device 104 include, but are not limited to, a handheld computer, a wearable computing device, a personal digital assistant (PDA), a tablet computer, a laptop computer, a desktop computer, a cellular telephone, a smart phone, an enhanced general packet radio service (EGPRS) mobile phone, a media player, a navigation device, a game console, a television, a remote control, or a combination of any two or more of these data processing devices or other data processing devices. Each client device 104 may include software applications for one or more of (1) interfacing with the social networking service module 126 to perform social networking activities (e.g., chat, posting messages on blogs, instant messaging with contacts, following another social network user), (2) interfacing with the commerce service module 128 to perform online seller-related activities (e.g., managing inventory, provide product description, fulfilling product orders, etc.) and/or online buyer-related activities (e.g., browsing online stores, comparing products, managing shopping carts, making online purchases, tracking online orders, provide online payments, provide product and seller reviews, etc.), (3) interfacing with the promotion configuration module 132 to provide user interfaces for a user to register as a seller (i.e., a top-level promoter) of a product or many products calling for promotion, to register as a sub-promoter of a product for an upper-level promoter, to configure one or more revenue sharing configurations for a product to be used with a sub-promoter, to elect or accept one or more revenue sharing configurations for a product offered by an upper-level promoter, to select one or more sub-promoters for a product that needs promotion, and/or to offer oneself as a sub-promoter for selection by one or more upper-level promoters, and (4) interfacing with the account settlement module 136 to obtain account settlement results and accept payments for successful sales of a product made through the promotion activities by the user as a promoter for the product, and to obtain promotion histories to share with potential upper-level promoters and potential buyers.

Examples of one or more networks 110 include local area networks (LAN) and wide area networks (WAN) such as the Internet. One or more networks 110 are, optionally, implemented using any known network protocol, including various wired or wireless protocols, such as Ethernet, Universal Serial Bus (USB), FIREWIRE, Global System for Mobile Communications (GSM), Enhanced Data GSM Environment (EDGE), code division multiple access (CDMA), time division multiple access (TDMA), Bluetooth, Wi-Fi, voice over Internet Protocol (VoIP), Wi-MAX, or any other suitable communication protocol.

Server system 108 is implemented on one or more standalone data processing apparatuses or a distributed network of computers. In some embodiments, server system 108 also employs various virtual devices and/or services of third party service providers (e.g., third-party cloud service providers) to provide the underlying computing resources and/or infrastructure resources of server system 108.

Server-client environment 100 shown in FIG. 1A includes both a client-side portion (e.g., client-side module 102) and a server-side portion (e.g., server-side module 106). In some embodiments, data processing is implemented as a standalone application installed on client device 104. In addition, the division of functionalities between the client and server portions of client environment data processing can vary in different embodiments. For example, in some embodiments, client-side module 102 is a thin-client that provides only user-facing input and output processing functions, and delegates all other data processing functionalities to a backend server (e.g., server system 108).

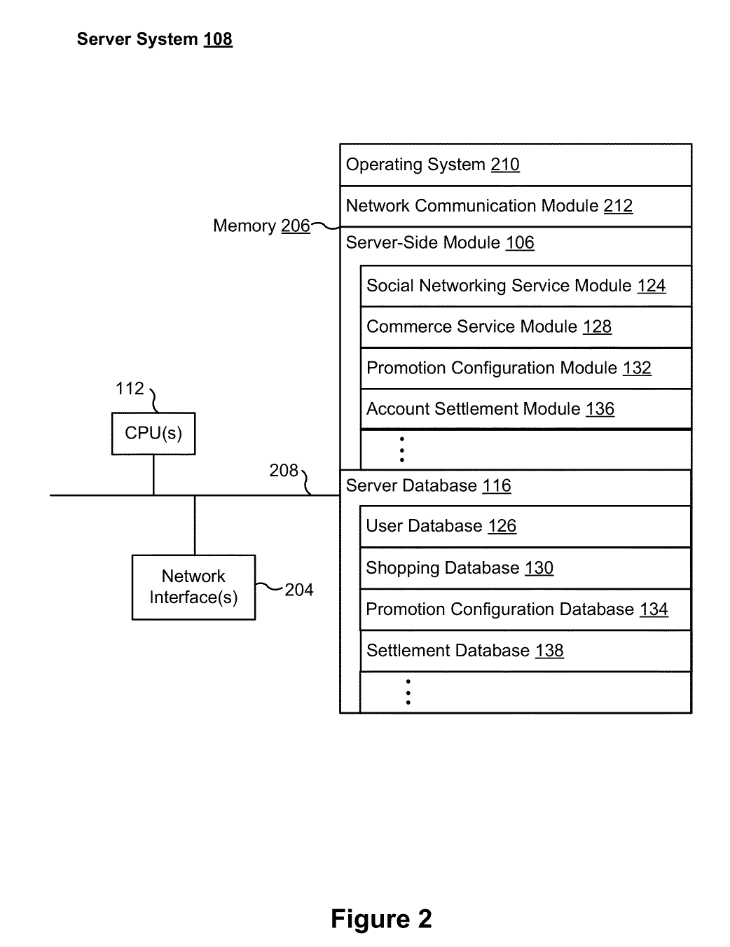

FIG. 2 is a block diagram illustrating a server system 108 in accordance with some embodiments. Server system 108, typically, includes one or more processing units (CPUs) 112, one or more network interfaces 204 (e.g., including I/O interface to one or more clients 118 and I/O interface to one or more external services 120), memory 206, and one or more communication buses 208 for interconnecting these components (sometimes called a chipset). Memory 206 includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. Memory 206, optionally, includes one or more storage devices remotely located from one or more processing units 112. Memory 206, or alternatively the non-volatile memory within memory 206, includes a non-transitory computer readable storage medium. In some implementations, memory 206, or the non-transitory computer readable storage medium of memory 206, stores the following programs, modules, and data structures, or a subset or superset thereof:
operating system 210 including procedures for handling various basic system services and for performing hardware dependent tasks;
network communication module 212 for connecting server system 108 to other computing devices (e.g., client devices 104 and external service(s) 122) connected to one or more networks 110 via one or more network interfaces 204 (wired or wireless);
server-side module 106, which provides server-side data processing for the commerce, promotion, and social networking platforms, which optionally includes some or all of the following sub-modules, but is not limited to:
   social networking service module 124 for providing social networking services such as managing and routing instant messages exchanged during a chat session among users of the social networking platform or posting of messages on a public bulletin board or personal blog or micro-blogs;
   commerce service module 128 for facilitating online sales and purchases of goods and services;
   promotion configuration module 132 for registering sellers and intermediate promoters for goods and services, searching for suitable upper-level and/or sub-promoters based on products and past sales/promotion records, adding selected contacts from one or more social network platforms as sub-promoters for a product in response to a promoter's request, establishing promotion contractual relationships between upper-level and lower-level promoters, establishing and configuring variable revenue sharing configurations based on user's inputs (i.e., users who have registered to be a promoter or users who have accepted to be a sub-promoter by selecting a link on a shared merchandise from an existing promoter of the merchandise);
   account settlement module 136 for identifying the promotion chain for a product sale based on an online purchase, identifying the promoters in the promotion chain and their corresponding revenue sharing configurations, determining the values for the variable parameters in the relevant revenue sharing configurations, and determining the proper division of costs and revenues among the promoters in the promotion chain and other stakeholders (e.g., insurance companies, banks, payment transaction services, social network platform providers, commerce service platform providers, promotion service platform providers, etc.) based on the revenue sharing configurations and the variable values in the revenue sharing configurations;
one or more server databases 116 storing data for the commerce, promotion, and social networking platforms, which optionally includes some or all of the following databases, but is not limited to:
   user database 126 storing user information such user IDs, user characteristics (e.g., location, age, gender, active duration, current online status, etc.), contact lists for each user, follower lists for each user or public account, online activity histories (e.g., chat histories, posting histories, etc.);
   shopping database 130 storing seller IDs, seller information (location, product type, store type, user reviews, account information, etc.), inventory information, merchandise information, order information, shopper IDs, shopper information (e.g., shopping carts, past purchase, account information, reviews by sellers, etc.), etc.;
   promotion configuration database 134 for storing promoter IDs associated with each product being promoted, and their relative hierarchy in the promotion chain of the product, and respective variable revenue sharing configurations associated with each pair of promoters in each promotion chain for each promoted product;
   Settlement database storing account settlement information for each individual sale and/or aggregated account settlement information for each party.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, memory 206, optionally, stores a subset of the modules and data structures identified above. Furthermore, memory 206, optionally, stores additional modules and data structures not described above.

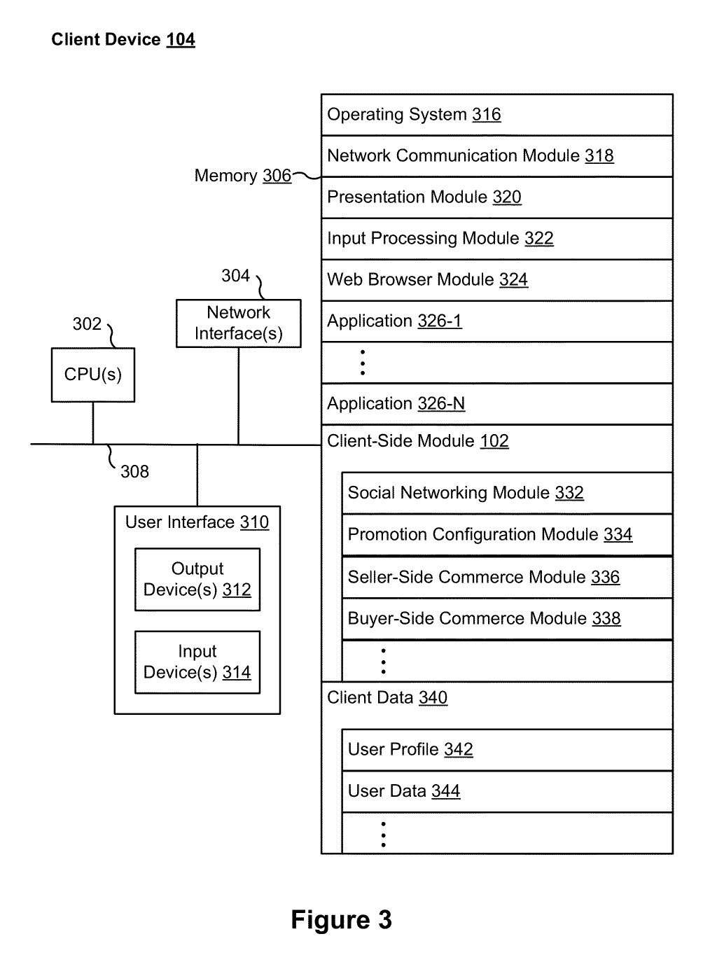

FIG. 3 is a block diagram illustrating a representative client device 104 associated with a user in accordance with some embodiments. Client device 104, typically, includes one or more processing units (CPUs) 302, one or more network interfaces 304, memory 306, and one or more communication buses 308 for interconnecting these components (sometimes called a chipset). Client device 104 also includes a user interface 310. User interface 310 includes one or more output devices 312 that enable presentation of media content, including one or more speakers and/or one or more visual displays. User interface 310 also includes one or more input devices 314, including user interface components that facilitate user input such as a keyboard, a mouse, a voice-command input unit or microphone, a touch screen display, a touch-sensitive input pad, a camera, a gesture capturing camera, or other input buttons or controls. Furthermore, some client devices 104 use a microphone and voice recognition or a camera and gesture recognition to supplement or replace the keyboard. Memory 306 includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. Memory 306, optionally, includes one or more storage devices remotely located from one or more processing units 302. Memory 306, or alternatively the non-volatile memory within memory 306, includes a non-transitory computer readable storage medium. In some implementations, memory 306, or the non-transitory computer readable storage medium of memory 306, stores the following programs, modules, and data structures, or a subset or superset thereof:
operating system 316 including procedures for handling various basic system services and for performing hardware dependent tasks;
network communication module 318 for connecting client device 104 to other computing devices (e.g., server system 108 and external service(s) 122) connected to one or more networks 110 via one or more network interfaces 304 (wired or wireless);
presentation module 320 for enabling presentation of information (e.g., a user interface for a social networking platform, a promotion configuration platform, an online shopper platform, widget, webpage, game, and/or application, audio and/or video content, text, etc.) at client device 104 via one or more output devices 312 (e.g., displays, speakers, etc.) associated with user interface 310;
input processing module 322 for detecting one or more user inputs or interactions from one of the one or more input devices 314 and interpreting the detected input or interaction;
one or more applications 326-1-326-N for execution by client device 104 (e.g., games, application marketplaces, payment platforms, and/or other applications); and
client-side module 102, which provides client-side data processing and functionalities for the commerce/promotion/social networking platform(s), which optionally includes, but is not limited to, one or more of the following modules:
   social networking module 332 for sending messages to and receiving messages from other users of one or more social networking platforms (e.g., instant messaging, group chat, message board, message/news feed, and the like);
   promotion configuration module 334 for sharing a product for promotion with pre-registered sub-promoters, registering as a sub-promoter for a product and/or upper-level promoter, sharing a product for promotion or sale with a social network contact, establishing and configuring variable revenue sharing configurations for a product and/or a sub-promoter, searching and selecting upper-level promoters, searching and selecting lower-level promoters, etc.
   seller-side commerce module 336 for providing seller-side account management services for an online commerce platform (e.g., store management, inventory management, order fulfilling, receipt account management, shipping management, etc.);
   buyer-side commerce module 338 for providing buyer-side services, such as product browsing, shopping cart management, order tracking, making payments, provide reviews, etc.
client data 340 storing data associated with the commerce/promotion/social networking platform(s), including, but is not limited to:
   user profile 342 storing a user profile associated with the user of client device 104 including user a/account name or handle, login credentials to the social networking platform, promotion, and/or commerce platform(s), payment data (e.g., linked credit card information, app credit or gift card balance, billing address, shipping address, etc.), custom parameters (e.g., age, location, hobbies, etc.) for the user, social network contacts, groups of contacts to which the user belongs, and identified trends and/or likes/dislikes of the user; and
   user data 344 storing promotion data authored, saved, shared by the user of client device 104 in the commerce/promotion/social networking platform(s).

Each of the above identified elements may be stored in one or more of the previously mentioned memory devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various implementations. In some implementations, memory 306, optionally, stores a subset of the modules and data structures identified above. Furthermore, memory 306, optionally, stores additional modules and data structures not described above.

It should be understood that different client devices may serve different roles in the online commerce/promotion/social networking environment, and different users may serve different roles in the online commerce/promotion/social networking environment and utilize different functions provided by a given client device 104. For example, a user may be the seller for one product, an intermediate promoter for another product, a buyer of yet another product, a social network contact of one or more other users, a publisher of a blog, an administrator of a public account with many followers, and/or a webmaster of a website, etc. The same user may invoke different functions implemented on the same client device to perform these different roles, or utilize different client devices for these different roles. In some embodiments, a first user may be a buyer of a product through the promotion activity of a second user (e.g., an existing promoter of the product and a social network contact of the first user), and then decides to share the product with another contact (e.g., a third user) via the social network and become a sub-promoter of the product for the second user. In some embodiments, the first user may accept the revenue sharing configuration between him/herself and the second user (the first user's upper-level promoter) before sharing the product with the third user as a potential buyer. The first user may also configure a new revenue sharing configuration between him/herself and the third user before sharing the product with the third user as a sub-promoter of the first user.

In some embodiments, at least some of the functions of server system 108 are performed by client device 104, and the corresponding sub-modules of these functions may be located within client device 104 rather than server system 108. In some embodiments, at least some of the functions of client device 104 are performed by server system 108, and the corresponding sub-modules of these functions may be located within server system 108 rather than client device 104. Client device 104 and server system 108 shown in FIGS. 2-3, respectively, are merely illustrative, and different configurations of the modules for implementing the functions described herein are possible in various embodiments.

As noted in the background section of the present disclosure, the current account settlement systems do not offer support for variable revenue sharing configurations in online commerce.

For example, if a seller wishes to have a special promotion to old customers, and will offer 20 dollars cash back to the older customers when they spend 100 dollars. The existing account settlement systems do not provide a variable parameter that distinguishes between old customers and new customers when sales are made, and thus make it difficult for the seller to implement such a special promotion.

For another example, in the existing online commerce settings, if a seller utilizes a promoter to help it promote its products, and the promoter has sub-promoters that the promoter wishes to pay 50% of its 20 dollar promotion fees to help further promote the products, the promoter does not have a convenient way of establishing such a promotion revenue sharing configuration with its sub-promoters, and to have the sale proceeds automatically divided among the seller, the promoter, and the sub-promoters without setting up its own account clearing services. The existing account settlement service also does not provide a mechanism for adding a sub-promoter ad hoc without prior configuration and contractual agreements.

For yet another example, if a seller is interested in developing new customers in a city that expects to have increasing spending powers in the future, the seller may wish to offer a better revenue sharing deal (e.g., an extra 5 dollars for promotion fees) to a promoter that brings in new customers in that city. Since the existing account settlement service does not distinguish between the origins of the customers, such a revenue sharing configuration cannot be easily implemented.

There are many scenarios that a seller or a promoter may wish to implement a variable revenue sharing plan easily to fulfill various business purposes at different times and business context and climate, such as increasing reputation, increasing revenue, clearing inventory, creating cash flow, developing customer base of a particular characteristics (e.g., locale, age, interest, reputation, income level, influence level, etc.), making short-term sales goals, stretching out inventory, testing out sub-promoters, testing out new marketing strategies, etc. The existing revenue sharing configurations are rigid, and are not suitable for the fast and dynamic online promotions through social network contacts and personal relationships. The existing revenue sharing configurations also do not permit dynamic selection of sub-promoters via social network platforms (e.g., by sharing product information with a social network contact as an instant message) and offer variable revenue sharing based on the parameters of the actual sales that may happen through the promotion efforts of the sub-promoters. The existing account settlement service also does not allow a promoter of a product to further configure a revenue sharing configuration to be used with a sub-promoter that has not yet been selected (e.g., selection by the promoter from a list of social network contacts).

The present disclosure provides a method and system for configuring variable revenue sharing configurations in online commerce. The payment division rules in the revenue sharing configurations include variable parameters whose values are determined when the actual sale of an associated product is made. The variable parameters can be selected by the user setting up the payment division rules from virtually any parameters that the seller and/or promoters deem to be relevant to the goal and efforts of the promotion for the product. The actual payment divisions are adjusted based on the actual values taken on by the variables based on the actual sale. Each pair of promoters adjacently positioned in a promotion chain (i.e., a promoter and its sub-promoter in a promotion chain for a product) can configure a respective variable revenue sharing configuration between themselves. In some embodiments, a respective variable revenue sharing configuration can be automatically selected for a sub-promoter from a number of revenue sharing configurations based on the instruction of the promoter and the relevant characteristic(s) of the sub-promoter. In some embodiments, different payment division rules may be selected based on the total past or present promotion performance of the sub-promoter. For example, if the total sale made through the promotion activity of a sub-promoter is above a certain threshold, he is eligible to choose a better payment division rule in the revenue sharing configuration established between the sub-promoter and its upper-level promoter.

The following is an example of establishing variable revenue sharing in online commerce in accordance with some embodiments.

In some embodiments, first, each promoter (including the seller as the top-level promoter) of a product establishes a respective revenue sharing configuration between itself and its sub-promoter in a promotion chain. The promotion chain can be in existence already, or being built gradually by adding one promoter at a time. In some embodiments, each revenue sharing configuration between a promoter and its sub-promoter can include at least a sale price and a promotion price, where the promotion price is the price that the promoter offers to the sub-promoter for the sale of a merchandise item, and the sale price is the price that the promoter offers to a potential buyer for purchasing the merchandise. Specifically, on a commerce platform, there are two concepts, “product” and “merchandise”. The same product may have different descriptions and different prices, different payment division rules, or other different related information that make the product into different “merchandise.” Each promoter creates its own merchandise item based on the merchandise item it receives from its upper-level promoter, and provides its own sale price, promotion price, and promotion configuration for sharing with buyers or its own sub-promoters. The merchandise of the seller is the product itself, and the merchandise of each sub-promoter is the merchandise of its upper-level promoter that has been repackaged (e.g., with new prices, description, incentives, etc.) by the sub-promoter.

In some embodiments, the respective revenue sharing configuration between a promoter and its sub-promoter includes a suggested price and a minimum price for the corresponding merchandise in online commerce, where the suggested price is higher than the minimum price. Specifically, there are promoters and regular buyers on the commerce platform. A promoter of a product includes the sequence of all parties that are in the promotion chain of the product linking the seller to the buyer. For a merchandise item on sale, the revenue sharing configuration can specify a promotion price, a suggested price, a minimum price and a sale price, where sale price minus the promotion price is the bulk sale price. The bulk sale price refers to the amount of payment received by a promoter when the merchandise is sold to a buyer through the promotion of a sub-promoter of the promoter. A sub-promoter can see the promotion price, suggested price, minimum price, and sale price offered by its upper-level promoter, while a buyer can only be shown the sale price. When a buyer pays an amount that exceeds the bulk sale price of a merchandise item, the extra amount will be paid to the sub-promoter of the product. Suggested price is the sale price suggested by the promoter. Suggested price, promotion price, and sale price are all no lower than the minimum price.

In some embodiments, each promoter can establish different revenue sharing configurations for its sub-promoters based on different properties of the online sales of its merchandise.

In some embodiments, the different properties of the online sales of merchandise include buyer properties, merchandise properties, sale quantity, sale amount, sale time, customer origin/location, type of sale platform, etc. In some embodiments, when a merchandise item is put on sale, different payment division rules can be established based on different conditions. For example, the payment division can be based on buyer properties. When a returning customer makes a purchase of the merchandise, the promoter offers 10% of the sale price to its sub-promoter as the promotion fees; and when a new customer makes a purchase of the same merchandise, the promoter offers 20% of the sale price to its sub-promoter as the promotion fees.

In some embodiments, each merchandise item can correspond to multiple payment division rules. In an example embodiment, each relevant property may be assigned a respective property identifier. For example, “new customer” is identified by 1, and “returning customer” is identified by 2, “customer located in Shanghai” is identified by 3, “total purchase amount exceeds 1000 dollars” is identified by 4, etc. Each of the payment division rules will specify the relevant properties for the payment division rule. For example, when the property identifier in a payment division rule is −1, then the default division rule is used. When a merchandise has multiple payment division rules (e.g., in the revenue sharing configuration), the property identifiers associated with each sale of the merchandise is compared to the property identifiers specified in each of the payment division rules, if the property identifiers of the sale matches the property identifiers specified in a payment division rule, the payment division rule should be used to divide the payments among the promoter and its sub-promoter (and any other parties that require service payments). When the property identifiers of the sale do not match the property identifiers specified in any of the payment division rules, the default payment division rule should be used to divide the payments among the promoter and its sub-promoter (and any other parties that require service payments).

In some embodiments, a sub-promoter can establish a revenue sharing configuration with its own sub-level promoter for a group of merchandise, and include a default payment division rule in the revenue sharing configuration. In some embodiments, a sub-promoter can establish a revenue sharing configuration for a category of merchandise, and to include payment division rules based on the identity of the upper-level promoter, the type of the merchandise, and the identity of its own sub-promoters. In some embodiments, when setting the payment division rules, the promotion price, the suggested price, the minimum price, and the sale price provided by the upper-level promoter can be used as parameters in the payment division rules. For example, a sub-promoter can set that, for the merchandise provided by upper-level promoter A, the sale price is equal to 120% of the original sale price, the promotion price is equal to the original promotion price, and the minimum price is equal to the original minimum price plus 10 dollars. When each merchandise item has its own associated payment division rule, that payment division rule is used, and if the merchandise does not have its own associated payment division rule, the default payment division rule is used.

In some embodiments, due the complexity of the payment division rules, when a merchandise item is put on sale, the payment division rules associated with the merchandise can be uploaded to a promotion configuration database, where each payment division rule is assigned a respective identifier number. In the actual payment processing process, the payment instruction can specify which payment division rule should be used. In addition, in order to prevent unauthorized tampering of the payment division rules during account settlement, the transmission of the identifiers of the payment division rules can be encrypted and made tamper-proof.

In some embodiments, after the revenue sharing configurations have been obtained from each promoter of a product in a promotion chain have been obtained, the server can perform the conflict or compatibility check on the received revenue sharing configurations.

For example, in some embodiments, the server can determine whether all of the revenue sharing configurations of all the promoters in the promotion chain are compatible with one another, and corrects the revenue sharing configurations that pose a conflict with each other. Specifically, in some embodiments, the server determines the validity of the revenue sharing configuration (including its payment division rules). When a payment division rule based on a particular property is uploaded, the server determines whether the new payment division rule would conflict with any of the existing payment division rules. Thus, the possibility that there are multiple payment division rules for use of a same sale between a promoter and its sub-promoter can be avoided.

The promotion of the product proceeds through the promotion chain from one promoter to its sub-promoter until the product is purchased by a buyer at the end of the promotion chain. It is to be noted that the last promoter in the promotion chain for the sale of the product may have other sub-promoters, but those sub-promoters are not included in the promotion chain for the sale of this product. So, multiple sales of the same product may go through different promotion chains originating from the seller to different buyers, the different promotion chains may include different number and identities of promoters up to the buyer in each of the promotion chains.

The payment received for the merchandise of each promoter is divided among the last promoter before the buyer and all of the promoters above its level based on the revenue sharing configurations of the promoter and all the promoters above its level in the promotion chain.

In some embodiments, a management platform for online commerce can be realized using the following exemplary process:

1. When merchandise is put on sale by a promoter, the price configuration for the merchandise includes at least a promotion price and a sale price. The promotion price is the price offered to a sub-promoter, and the sale price is the price offered to a buyer.

2. The application process of a sub-promoter: A potential sub-promoter can apply to become a sub-promoter of an upper-level promoter for all merchandise or some of all the merchandise offered by the upper-level promoter. When the upper-level promoter accepts the application of the potential sub-promoter, the potential sub-promoter becomes a sub-promoter of the upper-level promoter. In some embodiments, an upper-level promoter of the merchandise can also appoint certain users as its sub-promoters for the merchandise.

3. The process for putting merchandise on sale: Each sub-promoter of the merchandise can establish its own payment division rules (e.g., in its own revenue sharing configuration) or modify an existing payment division rule to create a new merchandise for sale. This new merchandise is to be provided to lower-level promoters of the sub-promoter, and the new payment division rules dictate how proceeds received for the sale of the new merchandise through the promotion effort of the lower-level promoter is to be divided between the sub-promoter and the lower-level promoter. It is to be noted that the merchandise offered by the upper-level promoter, and the new merchandise offered by the sub-promoter are the same product with different merchandise information.

4. The account settlement after the transaction success. After a sale of a merchandise is made to a buyer, the corresponding promotion chain and corresponding revenue sharing configurations (including the corresponding payment division rules) of the promoters in the promotion chain can be identified. For example, the merchandise that has been purchased by a buyer has a merchandise identifier; and based on the merchandise identifier, a corresponding payment division rule and the merchandise identifier of its upper-level merchandise (i.e., the merchandise created by the upper-level promoter) can be identified. In this manner, all of the payment division rules on the promotion chain can be identified, aggregated, and used to determine the payment made to each participants of the sale (e.g., including the seller, all the promoters below the seller and above the buyer in the promotion chain, and all other parties that provided services and owed service fees for the sale).

The following is a more specific example used in promotion on a social networking platform.

For example, merchant A has merchandise (e.g., seller A has a product) that he wishes to offer for sale, and would like to promote the merchandise on a social network. The sale price of the merchandise is 100 dollars. Merchant A would be willing to offer 50 dollars to its sub-promoter for the merchandise. Merchant A also specifies that if the buyer brought by the sub-promoter is a returning customer, then the sub-promoter will only be paid 20 dollars.

When Promoter B sees the merchandise of Merchant A, he would like to become the sub-promoter of Merchant A for the merchandise. In addition to promoting the merchandise to buyers, he will also have his friends to become his own sub-promoters to help with the promotion of the merchandise. Promoter B is willing to give 20 dollars to its own sub-promoter for the promotion of the merchandise, if a successful sale is made through the promotion efforts of its sub-promoter.

Promoter C is a friend of Promoter B, and he becomes sub-promoter of Promoter B for promoting the merchandise.

In a more specific scenarios, Merchant A will put a product on sale, and specifies that the sale price is 100 dollars for returning customers, and the corresponding promotion price is 80 dollars; and the sale price is 100 dollars for new customers, and the corresponding promotion price is 50 dollars. Regular buyers are only shown the sale price of 100 dollars. Promoter B will see the promotion prices after he becomes the sub-promoter of Merchant A for the merchandise. When Promoter B becomes the sub-promoter of Merchant A, merchandise G1 is created based on the product, and the merchandise G1 corresponds to two different payment division rules F1 and F2. F1 is the payment division rule applicable to a sale to a returning customer, and specifies that the sub-promoter (e.g., Promoter B) gets 20 dollars for the sale. F2 is the payment division rule applicable to a sale to a new customer, and specifies that the sub-promoter (e.g., Promoter B) gets 50 dollars as promotion fees for the merchandise.

Promoter B applies to become a sub-promoter of Merchant A, and is approved by Merchant A. Promoter B then generates new merchandise G2 by creating new payment division rules on the basis of the payment division rules (e.g., F1 and F2) associated with merchandise G1. The new merchandise G2 is configured to have a sale price of 100 dollars, and a promotion price of 80 dollars. The new merchandise G2 is associated with a new payment division rule F3 which specifies that the sub-promoter of Promoter B will get 20 dollars, and that the upper-level merchandise is G1 (with associated upper-level promoter being Merchant A).

Promoter B sets Promoter C as his own sub-promoter for the new merchandise G2, and Promoter C shared the merchandise G2 to a buyer and the sale was successfully completed. At this time, the account settlement can be performed based on the payment division rules involved in the promotion chain of the product that is sold to the buyer. In this example scenarios, the buyer bought merchandise G2 which is associated with the payment division rule F3. All the upstream merchandise involved in the promotion chain need to be identified. In this example, the upper-level merchandise of G2 is G1, and G1 is associated with payment division rules F1 and F2. During the account settlement process, all of the relevant payment division rules (e.g., F1, F2, and F3) are collected for the payment calculation. If the buyer is a new customer, Merchant A gets 50 dollars, Promoter B gets 30 dollars, and Promoter C gets 20 dollars.

The above exemplary method allows the promoter on each level of the promotion chain to configure the payment division rules for the division of proceeds obtained for the sale of a product online, and allows the real-time account settlement to be done at the time of the actual sale.

In the above example, a potential promoter can apply to become the sub-promoter of another promoter (including directly to a seller of a product) for merchandise put on sale by the promoter. In some embodiments, a promoter of merchandise can also select others as its sub-promoters for its merchandise. In some embodiments, a marketplace of available promoters of merchandise can be provided to users who are interested in becoming sub-promoters to browse and select from. Similarly, a marketplace of available lower-level promoters can be made available to existing promoters of merchandise to browse and select as sub-promoters. In some embodiments, the commerce server or the promotion configuration server collects the promotion records for each promoter (e.g., total sale quantity, promotion history, merchandise categories, etc.) and allow the promoters to be searched by various keywords and parameters.

When a promoter of a product creates a merchandise item to be displayed in an online storefront controlled by the promoter, or to be shared over a social network platform to friends and contacts of the promoter, the promoter can offer the merchandise for sale to buyers as well as for sub-promoters to promote to others. In some embodiments, a user becomes a sub-promoter by entering into an agreement with an upper-level promoter before sharing the merchandise of the upper-level promoter with a buyer or its own sub-promoters. For example, the user can accept the revenue sharing configuration specified by the upper-level promoter for the merchandise offered by the upper-level promoter in the online marketplace mentioned above. In some embodiments, the user can become a sub-promoter of an upper-level promoter by creating its own merchandise based on the merchandise of the upper-level promoter shared to the user by the upper-level promoter via a social network (e.g., via an instant message), where the new merchandise includes the user's own revenue sharing configuration. The user's own revenue configuration includes the sale price for a buyer who buys the new merchandise from the user (i.e., buys the product from the seller via a link or page provided to the buyer by the user), and the promotion price that the user offers to its own sub-promoters. In some embodiments, the user becomes the sub-promoter of the upper-level promoter when the user actually shares the newly created merchandise to another user (e.g., a buyer or a sub-promoter of the user) via an online storefront, a webpage, or a social network.

As shown in 4A, a user (e.g., User A) can enter a promotion management interface 402 to set up the revenue sharing configuration for a product (e.g., a sweater) (e.g., as a seller of the product) or a merchandise item for which User A has become a sub-promoter. In the user interface 402, User A can set up a new merchandise item that has a sale price (e.g., 100 dollars) that User A is willing to offer to a buyer, and a promotion price (80 dollars) that User A is willing to offer to a sub-promoter of User A. In other words, if the merchandise item is sold to a buyer by User A directly, User A gets 100 dollars for the sale; and if the merchandise is sold to a buyer for 100 dollars through the promotion of a sub-promoter of User A, User A gets 80 dollars, and the sub-promoter gets the remaining 20 dollars. Of course, if the sub-promoter offers the merchandise to a buyer for 90 dollars, when the sale is made, User A gets 80 dollars, and the sub-promoter gets the remaining 10 dollars. The exact account settlement for User A and its sub-promoter depends on the revenue sharing configuration (including the payment division rules) between User A and its upper-level promoter (if any), and the revenue sharing configuration (including the payment division rules) between User A and its sub-promoter, if the sale is made through the promotion of the sub-promoter.

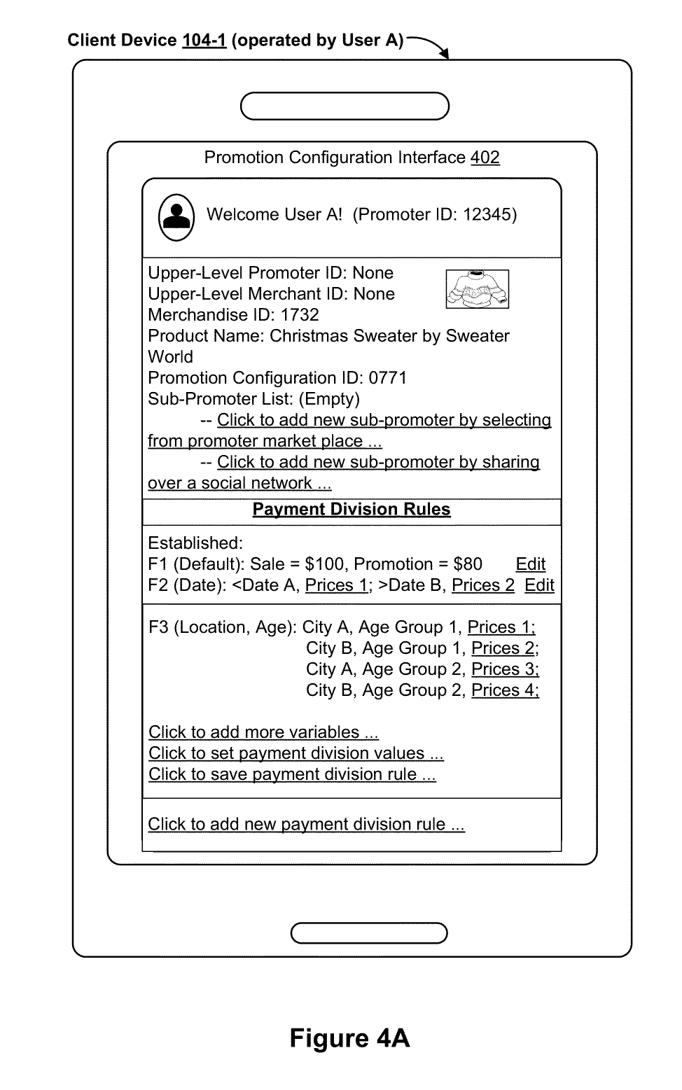

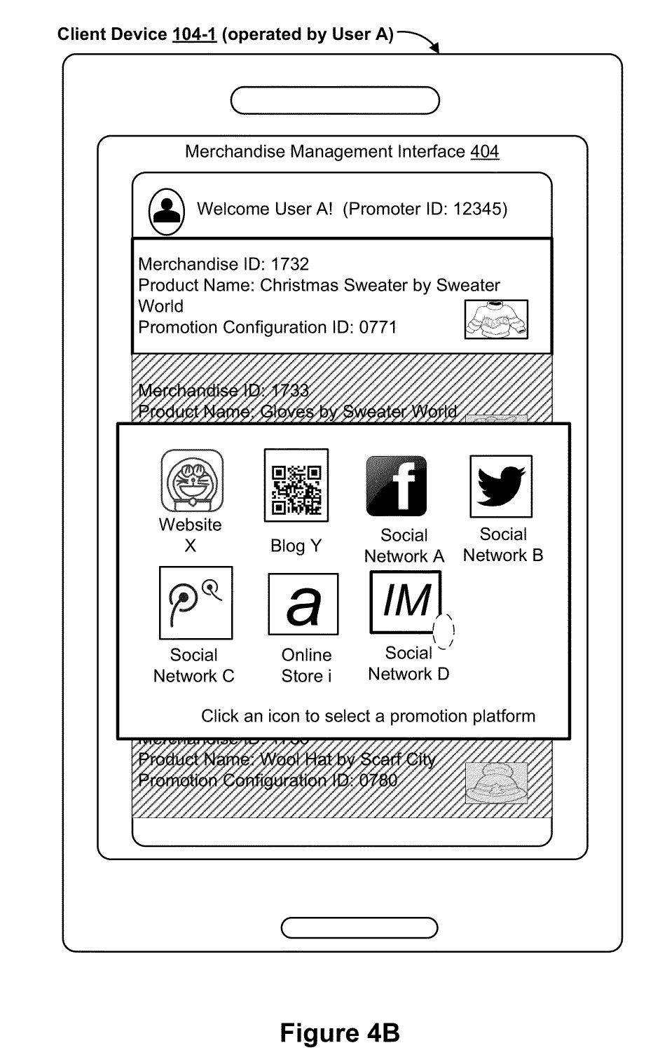

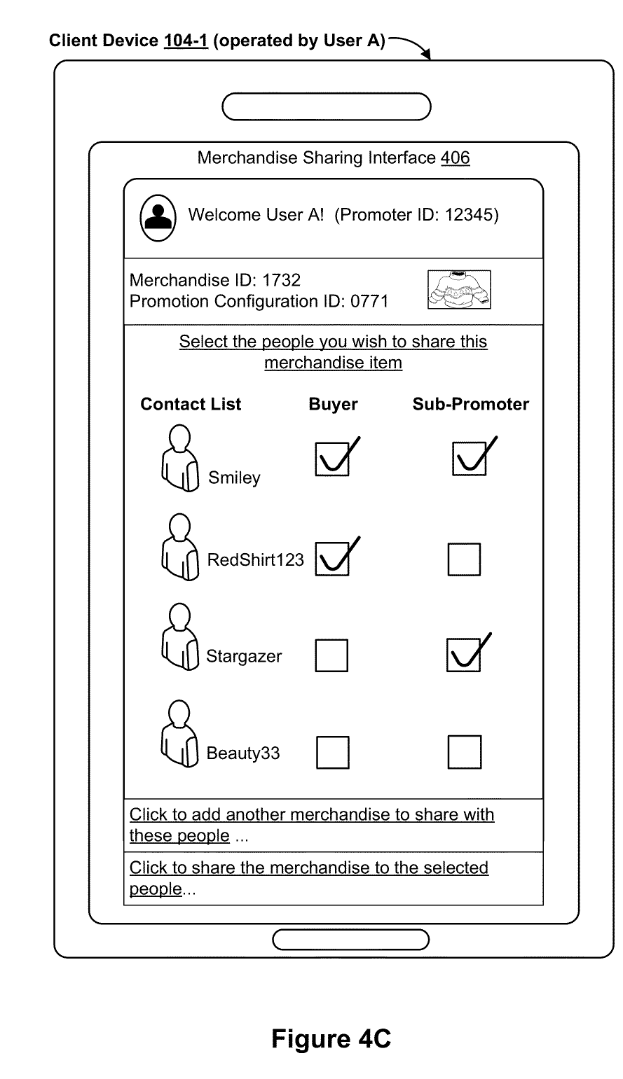

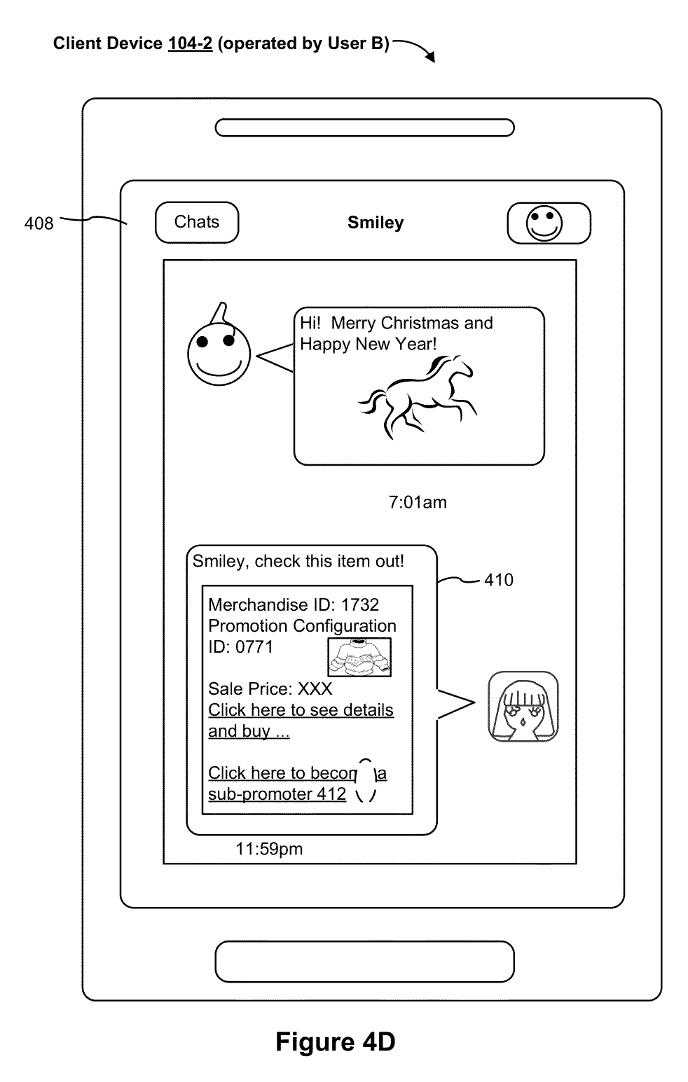

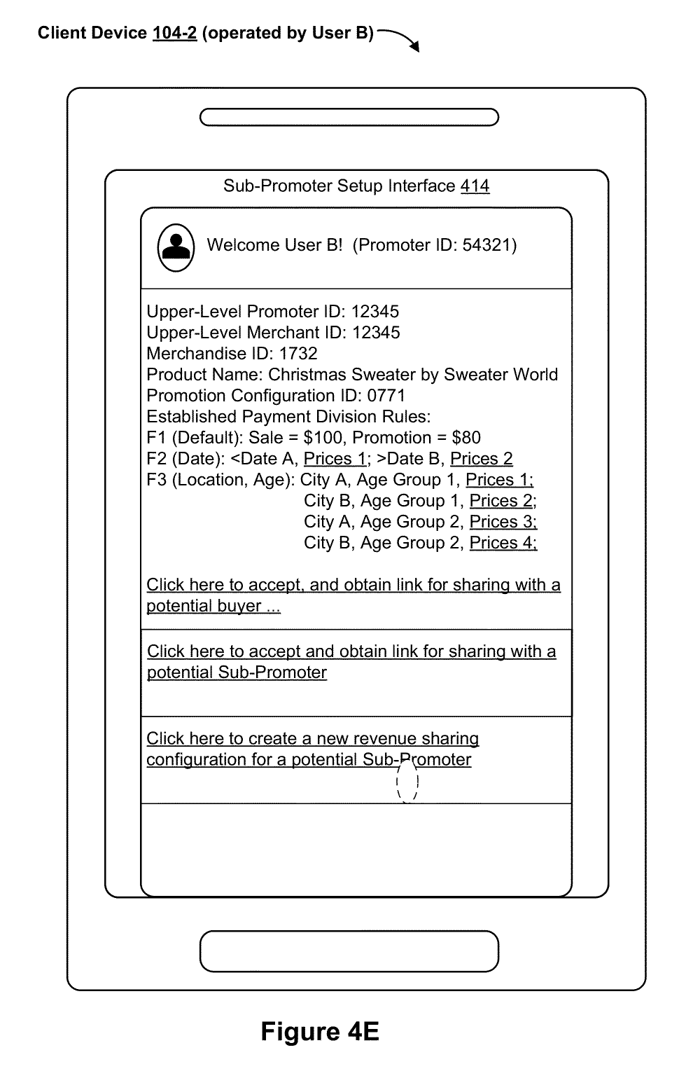

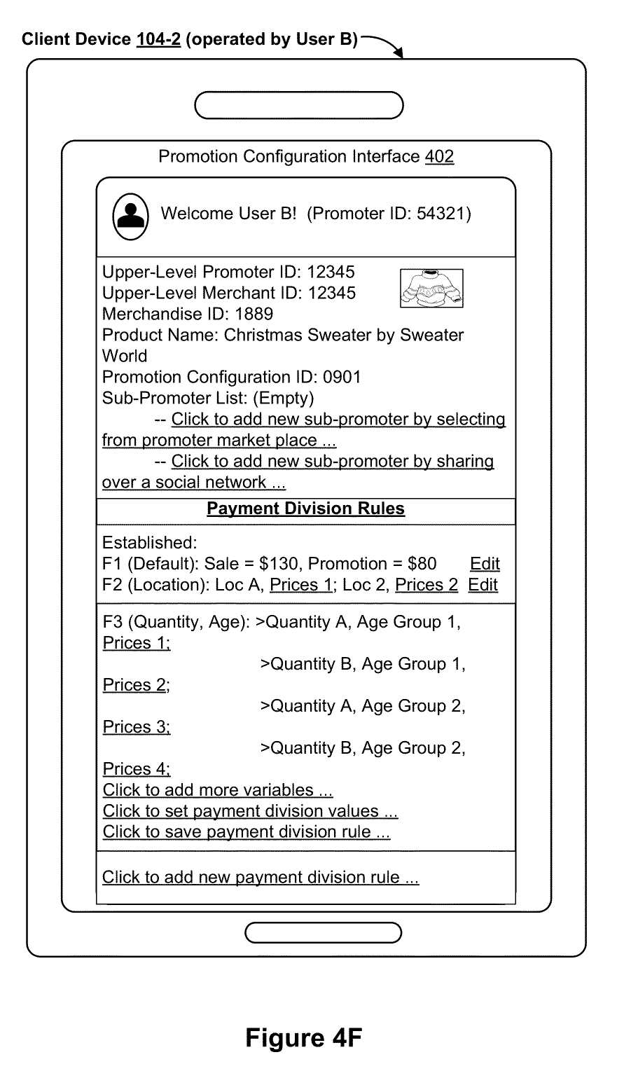

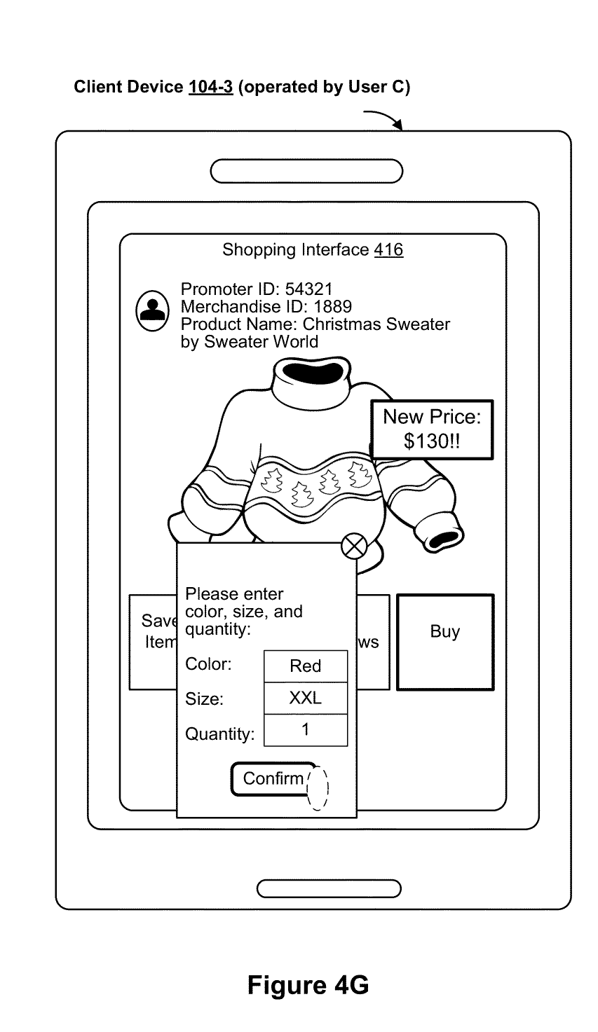

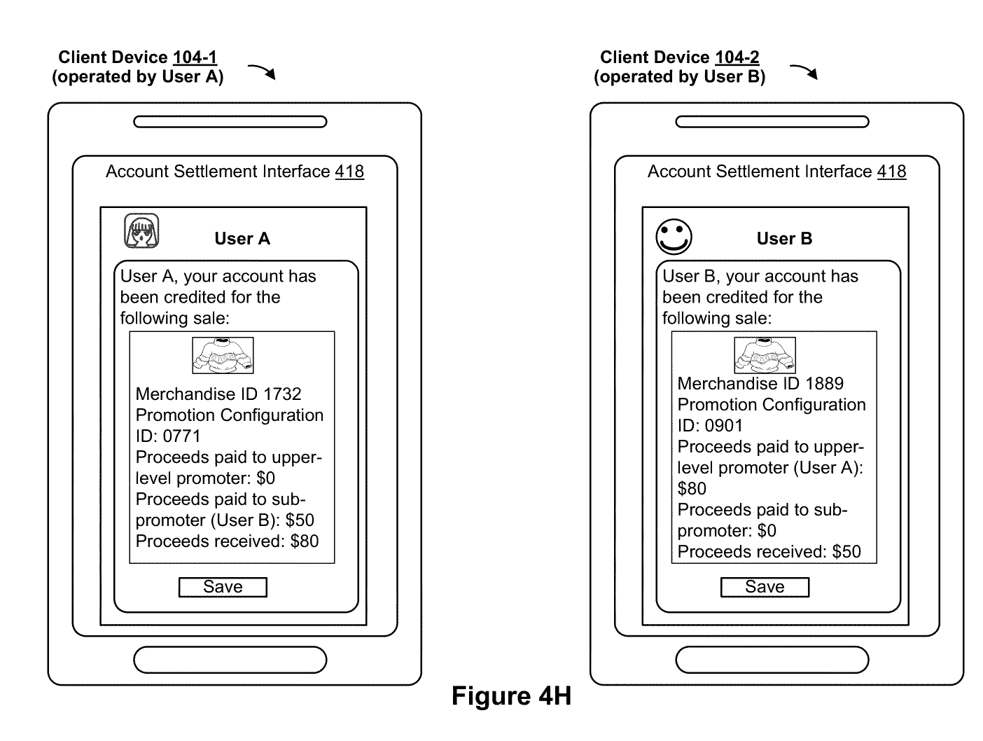

As shown in FIG. 4A, the revenue sharing configuration can include a default payment division rule F1 as described above, and also one or more payment division rules each including one or more variables. For example, the payment division rule F2 includes a variable parameter of sale time. If the sale occurs before Date A, the sale price to a buyer would be 95 dollars, and the promotion price to a sub-promoter would be 75 dollars; while if the sale occurs after Date B, the sale price to a buyer would be 100 dollars, and the promotion price to a sub-promoter would be 85 dollars. Another payment division rule F3 can have two variable parameters, e.g., location of the buyer, and age group of the buyer. For example, F3 specifies that if the buyer is from City A and in age group 18-25 years old, the sub-promoter gets 10 percent of the sale price X; if the buyer is from any other city, and in the age group 18-25 years old, the sub-promoter gets 5 percent of the sale price X; and if the buyer is from any other city, and in the age group 26 years old and above, the sub-promoter gets 1 percent of the sale price X, where X is a sale price set by the sub-promoter which must be above or equal to 100 dollars.

As shown in FIG. 4A, the user can also establish different payment division rules for different merchandise (identified by merchandise ID) and/or different upper-level promoters (identified by upper-level promoter ID or upper-level merchandise ID) and/or different sub-promoters. For example, the user can specify a payment division rule for major electronics (e.g., mobile phones) and a different payment division rule for peripherals (e.g., mobile phone cases, earphones, and other phone accessories). The user can also set up one payment division rule for merchandise received from upper-level promoter A, and a different payment division rule for merchandise received from upper-level promoter B. For example, if the upper-level promoter A offers a better promotion price to the user than upper-level promoter B does for the same product, the user can afford to offer a better promotion price to its own sub-promoters for promoter A's merchandise than for promoter B's merchandise. The user can also set up one payment division rule for sales or sub-promoters that receive the merchandise information from the user over an online storefront, and set up a different payment division rule for sales or sub-promoters that receive the merchandise information from the user over a social network (e.g., through an instant message to a social network contact). In some embodiments, in order to better manage the revenue sharing configurations the user has established, each revenue sharing configuration can be associated with a merchandise, a group of merchandise, an upper-level promoter, a group of upper-level promoter, a sub-promoter, a group of sub-promoters, and/or any combinations of the above. In addition, each payment division rule in a revenue sharing configuration can also be associated with a merchandise, a group of merchandise, an upper-level promoter, a group of upper-level promoter, a sub-promoter, a group of sub-promoters, a buyer property, a promoter property, a sub-promoter property, a sale context property (e.g., location, time, amount, quantity, product type, market condition, inventory level, etc.), and/or any combinations of the above.

Once the user has established the revenue sharing configuration in the user interface shown in FIG. 4A, the user can choose to share the created merchandise with a potential buyer or a potential sub-promoter. Sometimes, the merchandise information (e.g., including the sale price and the promotion price of the merchandise) can be provided on a webpage (e.g., in an online store), and waiting for potential buyers and potential sub-promoters to browse and select. Sometimes, the merchandise information can be sent to potential buyers and potential sub-promoters by the user through a social network platform. As shown in FIG. 4B, after User A has established the revenue sharing configuration for a merchandise item, User A can select the merchandise (e.g., the “Christmas Sweater” with merchandise ID 1732) from a merchandise management interface 404 to share it over a social network platform selected from a plurality of available promotion platforms (e.g., micro-blogs, websites, email, instant messaging platforms, message boards, public accounts, etc.). As shown in FIG. 4B, User A has selected a social network platform (e.g., an Instant Messaging platform “IM”) with instant messaging services to share the merchandise information.

As shown in FIG. 4C, after the selection of the social networking platform is done, the promotion configuration module obtains the list of contacts from the corresponding social networking service module, and displays them to User A in a merchandise sharing interface 406. User A selects one or more contacts (e.g., “Smiley”, Redshirt123, and Stargazer) from the selected social network platform shown in the sharing interface 406 as the potential buyers, potential sub-promoters, or both for the newly created merchandise (e.g., the “Christmas sweater” with merchandise ID 1732). In some embodiments, the promotion configuration module uses user data stored locally to determine the contacts in the selected social network. As shown in FIG. 4C, User A has selected a social network contact “Smiley” to be both a potential buyer and a potential sub-promoter for the merchandise, and confirmed that the merchandise information of the selected merchandise is to be sent to the selected contact(s) via the communication mechanism provided by the selected social network platform (e.g., via instant messaging). In some embodiments, User A can add more merchandise to be shared with the selected contacts in the merchandise sharing interface 406. In some embodiments, the promotion configuration module creates the message including the merchandise information (e.g., description of the merchandise) to be sent to the selected contact in the format acceptable by the social networking service module, and sends the message to the contact via the social networking service module on behalf of User A.

In FIG. 4D, on a client device 104-2 of the selected contact, namely User B (e.g., “Smiley”), the message containing the shared merchandise information has arrived, and is displayed to the contact in an instant messaging communication interface 408 of the selected social network platform. The message 410 displays the merchandise information which includes the sale price of the merchandise if the contact wishes to make a purchase. The message 410 also includes a user interface element 412 which, when selected, causes the revenue sharing configuration associated with the merchandise (e.g., the “Christmas sweater” with merchandise ID 1732) to be displayed. The revenue sharing configuration applies to User A and User B as promoter and sub-promoter of the merchandise.

In some embodiments, User B is not considered a sub-promoter of User A for the merchandise until User B has accepted the revenue sharing configuration (and its payment division rules). In some embodiments, User B is not considered as a sub-promoter of User A for the merchandise until User B has shared the merchandise with a potential buyer or a potential sub-promoter of User B.

In some embodiments, User B can select the “Buy” button in a merchandise details interface to make a purchase of the product at the sale price shown in FIG. 4D. For example, after the purchase order is completed, the order is sent to the original seller of the product by the commerce server, such that the product can be shipped by the seller to User B. At the same time, once the payment is made by User B as the buyer, the commerce service module notifies the account settlement module about the sale, and the payment. The account settlement module would identify the merchandise that has been sold (e.g., sweater with the merchandise ID 1732), and identifies the promotion chain that is used to promote the product from the seller to the buyer. User A is the last promoter for the product in the promotion chain before the buyer. In this example, User A may be the original seller of the product or a lower-level promoter of the product. In any event, the account settlement module can identify all the promoters in the promotion chain based on the information stored in the promotion configuration database. The account settlement module can further identify the revenue sharing configurations used between each pair of promoter and sub-promoter in the promotion chain. Then, based on the data regarding the actual sale, the account settlement module can determine the relevant payment division rules in the identified revenue sharing configurations and assign values to the variables in the payment division rules to determine how the payment received from User B as a buyer is to be distributed among the promoters in the promotion chain. In some embodiments, the account settlement module also identifies other participants in the sale of the product, such as insurance providers, shipping service providers, and commerce, promotion, and social networking service platform providers, and distributes an appropriate share of the payment to each.

As shown in FIG. 4D, User B selected the user interface element 412 for becoming a sub-promoter of User A for the merchandise. As shown in FIG. 4E, User B is shown the revenue sharing configuration provided by User A for the merchandise in a sub-promoter setup interface 414. In some embodiments, multiple revenue sharing configurations provided by User A can be shown, and User B can accept one that is most agreeable to him. In some embodiments, User B can choose to become a sub-promoter for the merchandise by accepting a revenue sharing configuration proposed by User A, and share the merchandise to a potential buyer. If that potential buyer makes a purchase of the product through the shared merchandise information from User B, then User B can receive the payment share according to the revenue sharing configuration. As shown in FIG. 4E, when User B chooses to accept the revenue sharing configuration of User A for the merchandise, User B is provided with a link which he or she can share with a potential buyer in any manner he/she wishes (e.g., via an instant message to a friend, or post it on a personal webpage, or post on a public forum, etc.). In some embodiments, the merchandise information can also be stored in User B's promoter account, and User B can manage the merchandise through the promotion management interface as that shown in FIGS. 4A-4C.

If User B decides to find its own sub-promoters for the product, User B can select the user interface element for creating a new revenue sharing configuration. If User B selects this user interface element, the user can be presented with a user interface analogous to that shown in FIGS. 4A-4C, and go through the same steps to configure his own revenue sharing configuration for his own sub-promoters, and select the sub-promoters to share the new merchandise information. FIG. 4F shows the promotion configuration interface 402 on User B's client device 104-2, which shows that User B has created a new merchandise (merchandise ID 1889) based on the merchandise provided by User A, and has established a new revenue sharing configuration for the new merchandise. In some embodiments, the promotion configuration module identifies the promotion configurations for all the promoters above User B in the promotion chain of the product to make sure the new revenue sharing configuration is compatible with the existing revenue sharing configurations in the promotion chain.

As shown in FIG. 4G, User B has shared the merchandise information with a potential buyer (e.g., User C) by sending the link made for the potential buyer, and the link has been displayed on the potential buyer's (e.g., User C's) client device 104-3. When the potential buyer User C makes a purchase of the product according to the sale price specified by User B, the payment is processed by the commerce service module and the sale is notified to the account settlement module. As shown in FIG. 4G, User C has confirmed a purchase of the merchandise shared by User B in a shopping interface 416. The account settlement module identifies User B as the last promoter in the promotion chain for the sale, and User A as the upper-level promoter of User B in the promotion chain. The account settlement module also identifies all the promoters above the level of User B in the promotion chain up to the seller of the product (in this particular example, there are none. But in other examples, there can be one or more such higher level promoters).

In accordance the actual sale information, the account settlement module identifies all the relevant revenue sharing configurations (including the payment division rules), assigns values to the variable parameters in the payment division rules to determine the payment division rules. Once the payment received from the user is distributed to the different promoters in the promotion chain and all other participants in the sale, the sale notification is sent to each promoter. For example, FIG. 4H shows an account settlement interface 418, which shows the account settlement notification sent to User A, and the account settlement notification sent to User B for the sale made to the buyer (e.g., User C) found by User B. In this example, the buyer paid 130 dollars for the product, and 80 dollars is given to User A based on the revenue sharing configuration specified by User A and accepted by User B, and 50 dollars is given to User B. If User A had any upper-level promoters for the product, the 80 dollars would be divided between the upper-level promoters and User A in the promotion chain according to their revenue sharing configurations and other parties that have provided services for a cost.

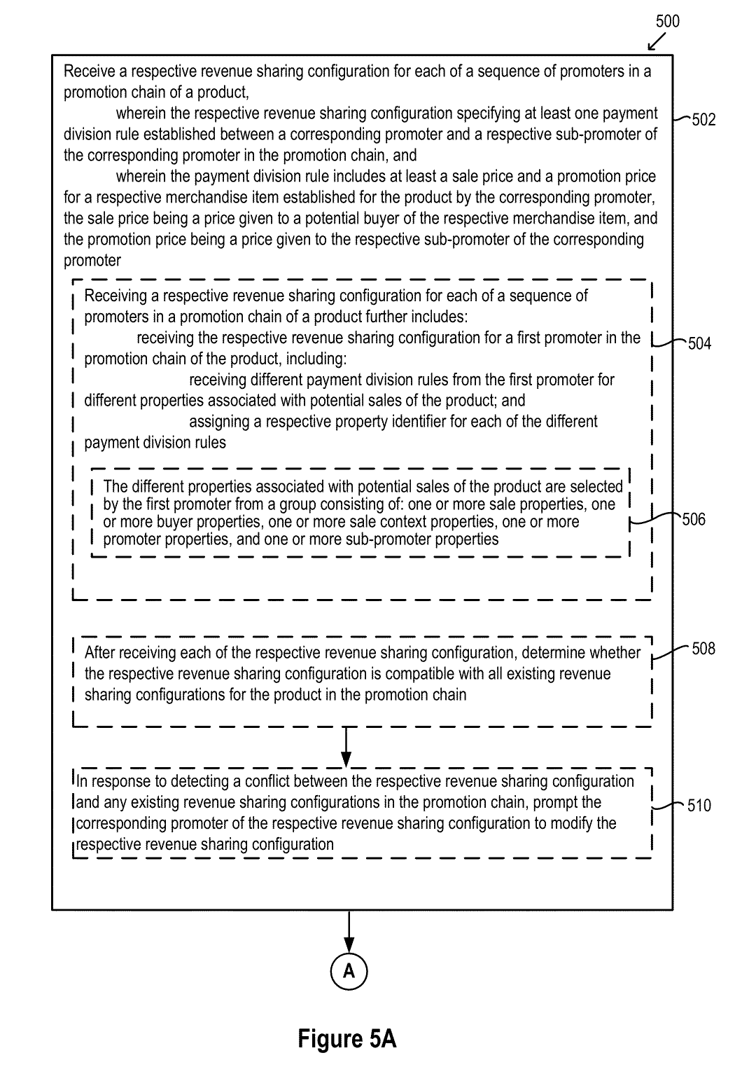

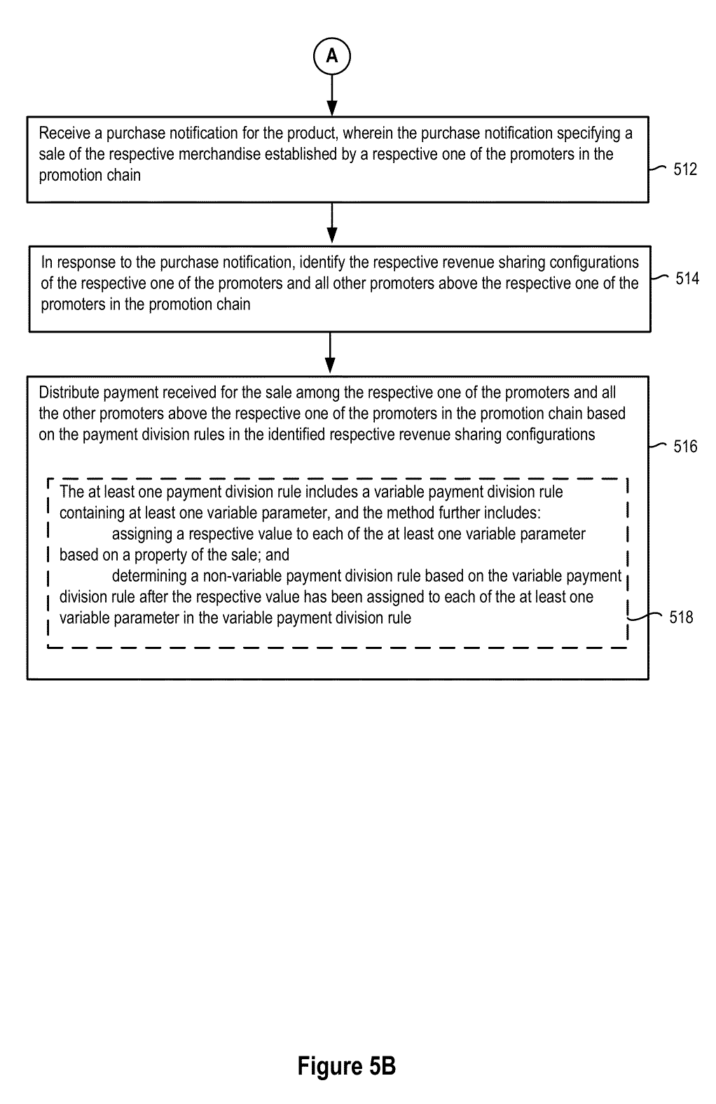

FIGS. 4A-4H illustrate exemplary user interfaces for commerce/promotion/social networking platform(s) displayed on different client devices 104 (e.g., a mobile phone) as the client devices serve different roles in the online promotion and sale transaction; however, one skilled in the art will appreciate that the user interfaces shown in FIGS. 4A-4H may be implemented on other similar computing devices. The user interfaces in FIGS. 4A-4H are used to illustrate the processes described herein, including the processes described with respect to FIGS. 5A-5B.

FIGS. 5A-5B are a flowchart diagram of a method 500 of providing configurable variable revenue sharing in online commerce in accordance with some embodiments. In some embodiments, method 500 is performed by a server system 108 with one or more processors and memory. For example, in some embodiments, method 500 is performed by server system 108 (FIGS. 1A-1B, and FIG. 2) or a component thereof (e.g., server-side module 106 or one or more sub-modules thereof, FIGS. 1A-1B and FIG. 2). In some embodiments, method 500 is governed by instructions that are stored in a non-transitory computer readable storage medium and the instructions are executed by one or more processors of the server system. Optional operations are indicated by dashed lines (e.g., boxes with dashed-line borders).

In some embodiments, the server system 108 receives (502) a respective revenue sharing configuration for each of a sequence of promoters in a promotion chain of a product, where the respective revenue sharing configuration specifies at least one payment division rule established between a corresponding promoter and a respective sub-promoter of the corresponding promoter in the promotion chain, and where the payment division rule includes at least a sale price and a promotion price for a respective merchandise item established for the product by the corresponding promoter, the sale price being a price given to a potential buyer of the respective merchandise item, and the promotion price being a price given to the respective sub-promoter of the corresponding promoter.

In some embodiments, receiving a respective revenue sharing configuration for each of a sequence of promoters in a promotion chain of a product further includes (504) receiving the respective revenue sharing configuration for a first promoter (e.g., any promoter in the chain) in the promotion chain of the product, including: receiving different payment division rules from the first promoter for different properties associated with potential sales of the product; and assigning a respective property identifier for each of the different payment division rules.

In some embodiments, the different properties associated with potential sales of the product are (506) selected by the first promoter from a group consisting of: one or more sale properties (e.g., sale location, sale time, sale quantity, product category, sale price, etc.), one or more buyer properties (e.g., buyer age, buyer gender, buyer influence, buyer race, etc.), one or more sale context properties (e.g., promotion goals, market conditions, market forecast, inventory level, shipping backlog level, etc.), one or more promoter properties (e.g., promoter's past record, promoter's sharing platforms, total successful sales so far, etc., total successful promised, etc.), and one or more sub-promoter properties (e.g., similar to promoter's properties).

In some embodiments, after receiving each of the respective revenue sharing configuration, the server determines (508) whether the respective revenue sharing configuration is compatible with all existing revenue sharing configurations for the product in the promotion chain. In response to detecting a conflict between the respective revenue sharing configuration and any existing revenue sharing configurations in the promotion chain, the server prompts (510) the corresponding promoter of the respective revenue sharing configuration to modify the respective revenue sharing configuration.

In some embodiments, after receiving each of the respective revenue sharing configurations, the server determines whether the payment division rules in the respective revenue sharing configuration are compatible with one another. In response to detecting a conflict between the payment division rules in the respective revenue sharing configuration, the server prompts the corresponding promoter of the respective revenue sharing configuration to modify at least one of the payment division rules in the respective revenue sharing configuration.

The server receives (512) a purchase notification for the product, wherein the purchase notification specifying a sale of the respective merchandise established by a respective one of the promoters in the promotion chain. In response to the purchase notification, the server identifies (514) the respective revenue sharing configurations of the respective one of the promoters and all other promoters above the respective one of the promoters in the promotion chain. The server then (516) distributes payment received for the sale among the respective one of the promoters and all the other promoters above the respective one of the promoters in the promotion chain based on the payment division rules in the identified respective revenue sharing configurations.

In some embodiments, at least one payment division rule includes (518) a variable payment division rule containing at least one variable parameter, and the method further comprises: assigning a respective value to each of the at least one variable parameter based on a property of the sale; and determining a non-variable payment division rule based on the variable payment division rule after the respective value has been assigned to each of the at least one variable parameter in the variable payment division rule. In some embodiments, the at least one variable is selected from the group consisting of one or more sale properties, one or more buyer properties, one or more sale context properties, one or more promoter properties, and one or more sub-promoter properties.

Other details of the method 500 as well as other methods performed by other modules, the client devices, etc. are disclosed with respect to FIGS. 1A-4H above, and are not repeated here.

It should be noted that, in the foregoing processes and structural diagrams, not all the steps and modules are necessary, and some steps or modules may be ignored according to actual needs. An execution sequence of steps is not fixed, and may be adjusted as required. Division of modules is merely functional division for ease of description; in an actual implementation, one module may be implemented by multiple modules, and functions of multiple modules may also be implemented by a same module; and these modules may be located in a same device, and may also be located in different devices.

Hardware modules in the embodiments may be implemented in a mechanical or electronic manner. For example, one hardware module may include a specially designed permanent circuit or logical device (for example, a dedicated processor, such as an FPGA or an ASIC), and is used for perform specific operations. The hardware module may also include a programmable logic device or a circuit temporarily configured by software (for example, including a general processor or other programmable processors), and is used for performing specific operations. Whether the hardware module is implemented by using a mechanical manner, or by using a dedicated permanent circuit, or by using a temporarily configured circuit (for example, configured by software) may be determined according to costs and time.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the application to the precise forms disclosed. Many modifications and variations are possible in view of the above teachings. The embodiments were chosen and described in order to best explain the principles of the application and its practical applications, to thereby enable others skilled in the art to best utilize the application and various embodiments with various modifications as are suited to the particular use contemplated.

What is claimed is:

1. A method of providing configurable variable revenue sharing in online commerce, comprising:
at a server having one or more processors and memory:
receiving a respective revenue sharing configuration for each of a sequence of promoters in a promotion chain of a product, wherein the respective revenue sharing configuration specifies at least one payment division rule established between a corresponding promoter and a respective sub-promoter of the corresponding promoter in the promotion chain, and wherein the payment division rule includes at least a sale price and a promotion price for a respective merchandise item established for the product by the corresponding promoter, the sale price being a price given to a potential buyer of the respective merchandise item, and the promotion price being a price given to the respective sub-promoter of the corresponding promoter;
receiving a purchase notification for the product, wherein the purchase notification specifies a sale of the respective merchandise established by a respective one of the promoters in the promotion chain;
in response to the purchase notification, identifying the respective revenue sharing configurations of the respective one of the promoters and all other promoters above the respective one of the promoters in the promotion chain; and
distributing payment received for the sale among the respective one of the promoters and all the other promoters above the respective one of the promoters in the promotion chain based on the payment division rules in the identified respective revenue sharing configurations.

2. The method of claim 1, wherein receiving a respective revenue sharing configuration for each of a sequence of promoters in a promotion chain of a product further comprises:
receiving the respective revenue sharing configuration for a first promoter in the promotion chain of the product, including:
receiving different payment division rules from the first promoter for different properties associated with potential sales of the product; and
assigning a respective property identifier for each of the different payment division rules.

3. The method of claim 2, wherein the different properties associated with potential sales of the product are selected by the first promoter from a group consisting of: one or more sale properties, one or more buyer properties, one or more sale context properties, one or more promoter properties, and one or more sub-promoter properties.

4. The method of claim 1, wherein the at least one payment division rule includes a variable payment division rule containing at least one variable parameter, and the method further comprises:
assigning a respective value to each of the at least one variable parameter based on a property of the sale; and
determining a non-variable payment division rule based on the variable payment division rule after the respective value has been assigned to each of the at least one variable parameter in the variable payment division rule.

5. The method of claim 1, wherein the at least one variable is selected from the group consisting of one or more sale properties, one or more buyer properties, one or more sale context properties, one or more promoter properties, and one or more sub-promoter properties.

6. The method of claim 1, further comprising:
after receiving each of the respective revenue sharing configuration, determining whether the respective revenue sharing configuration is compatible with all existing revenue sharing configurations for the product in the promotion chain; and
in response to detecting a conflict between the respective revenue sharing configuration and any existing revenue sharing configurations in the promotion chain, prompting the corresponding promoter of the respective revenue sharing configuration to modify the respective revenue sharing configuration.

7. The method of claim 1, further comprising:
after receiving each of the respective revenue sharing configuration, determining whether the payment division rules in the respective revenue sharing configuration are compatible with one another; and
in response to detecting a conflict between the payment division rules in the respective revenue sharing configuration, prompting the corresponding promoter of the respective revenue sharing configuration to modify at least one of the payment division rules in the respective revenue sharing configuration.

8. A server system, comprising:
one or more processors; and
memory storing one or more programs to be executed by the one or more processors, the one or more programs comprising instructions for:
receiving a respective revenue sharing configuration for each of a sequence of promoters in a promotion chain of a product, wherein the respective revenue sharing configuration specifies at least one payment division rule established between a corresponding promoter and a respective sub-promoter of the corresponding promoter in the promotion chain, and wherein the payment division rule includes at least a sale price and a promotion price for a respective merchandise item established for the product by the corresponding promoter, the sale price being a price given to a potential buyer of the respective merchandise item, and the promotion price being a price given to the respective sub-promoter of the corresponding promoter;
receiving a purchase notification for the product, wherein the purchase notification specifying a sale of the respective merchandise established by a respective one of the promoters in the promotion chain;
in response to the purchase notification, identifying the respective revenue sharing configurations of the respective one of the promoters and all other promoters above the respective one of the promoters in the promotion chain; and
distributing payment received for the sale among the respective one of the promoters and all the other promoters above the respective one of the promoters in the promotion chain based on the payment division rules in the identified respective revenue sharing configurations.

9. The system of claim 8, wherein receiving a respective revenue sharing configuration for each of a sequence of promoters in a promotion chain of a product further comprises:
receiving the respective revenue sharing configuration for a first promoter in the promotion chain of the product, including:
receiving different payment division rules from the first promoter for different properties associated with potential sales of the product; and
assigning a respective property identifier for each of the different payment division rules.

10. The system of claim 9, wherein the different properties associated with potential sales of the product are selected by the first promoter from a group consisting of: one or more sale properties, one or more buyer properties, one or more sale context properties, one or more promoter properties, and one or more sub-promoter properties.

11. The system of claim 8, wherein the at least one payment division rule includes a variable payment division rule containing at least one variable parameter, and the method further comprises:
assigning a respective value to each of the at least one variable parameter based on a property of the sale; and
determining a non-variable payment division rule based on the variable payment division rule after the respective value has been assigned to each of the at least one variable parameter in the variable payment division rule.

12. The system of claim 8, wherein the at least one variable is selected from the group consisting of one or more sale properties, one or more buyer properties, one or more sale context properties, one or more promoter properties, and one or more sub-promoter properties.

13. The system of claim 8, wherein the operations further comprise:
after receiving each of the respective revenue sharing configuration, determining whether the respective revenue sharing configuration is compatible with all existing revenue sharing configurations for the product in the promotion chain; and
in response to detecting a conflict between the respective revenue sharing configuration and any existing revenue sharing configurations in the promotion chain, prompting the corresponding promoter of the respective revenue sharing configuration to modify the respective revenue sharing configuration.

14. The system of claim 8, wherein the operations further comprise:
after receiving each of the respective revenue sharing configuration, determining whether the payment division rules in the respective revenue sharing configuration are compatible with one another; and
in response to detecting a conflict between the payment division rules in the respective revenue sharing configuration, prompting the corresponding promoter of the respective revenue sharing configuration to modify at least one of the payment division rules in the respective revenue sharing configuration.

15. A non-transitory computer readable storage medium storing one or more programs, the one or more programs comprising instructions, which, when executed by a server system with one or more processors, cause the server system to perform operations comprising:
receiving a respective revenue sharing configuration for each of a sequence of promoters in a promotion chain of a product, wherein the respective revenue sharing configuration specifies at least one payment division rule established between a corresponding promoter and a respective sub-promoter of the corresponding promoter in the promotion chain, and wherein the payment division rule includes at least a sale price and a promotion price for a respective merchandise item established for the product by the corresponding promoter, the sale price being a price given to a potential buyer of the respective merchandise item, and the promotion price being a price given to the respective sub-promoter of the corresponding promoter;
receiving a purchase notification for the product, wherein the purchase notification specifying a sale of the respective merchandise established by a respective one of the promoters in the promotion chain;
in response to the purchase notification, identifying the respective revenue sharing configurations of the respective one of the promoters and all other promoters above the respective one of the promoters in the promotion chain; and
distributing payment received for the sale among the respective one of the promoters and all the other promoters above the respective one of the promoters in the promotion chain based on the payment division rules in the identified respective revenue sharing configurations.

16. The computer-readable storage medium of claim 15, wherein receiving a respective revenue sharing configuration for each of a sequence of promoters in a promotion chain of a product further comprises:
receiving the respective revenue sharing configuration for a first promoter in the promotion chain of the product, including:
receiving different payment division rules from the first promoter for different properties associated with potential sales of the product; and
assigning a respective property identifier for each of the different payment division rules.

17. The computer-readable storage medium of claim 16, wherein the different properties associated with potential sales of the product are selected by the first promoter from a group consisting of: one or more sale properties, one or more buyer properties, one or more sale context properties, one or more promoter properties, and one or more sub-promoter properties.

18. The computer-readable storage medium of claim 15, wherein the at least one payment division rule includes a variable payment division rule containing at least one variable parameter, and the method further comprises:
assigning a respective value to each of the at least one variable parameter based on a property of the sale; and
determining a non-variable payment division rule based on the variable payment division rule after the respective value has been assigned to each of the at least one variable parameter in the variable payment division rule.

19. The computer-readable storage medium of claim 15, wherein the at least one variable is selected from the group consisting of one or more sale properties, one or more buyer properties, one or more sale context properties, one or more promoter properties, and one or more sub-promoter properties.

20. The computer-readable storage medium of claim 15, wherein the operations further comprise:
after receiving each of the respective revenue sharing configuration, determining whether the respective revenue sharing configuration is compatible with all existing revenue sharing configurations for the product in the promotion chain; and
in response to detecting a conflict between the respective revenue sharing configuration and any existing revenue sharing configurations in the promotion chain, prompting the corresponding promoter of the respective revenue sharing configuration to modify the respective revenue sharing configuration.
